(19) United States
(12) Patent Application Publication
(10) Pub. No.: US 2013/0047791 A1
(43) Pub. Date: Feb. 28, 2013

(54) STRUCTURE OF SOCKET WRENCH

(71) Applicant: JUNG-CHOU HSU, Taichung City (TW)

(72) Inventor: JUNG-CHOU HSU, Taichung City (TW)

(21) Appl. No.: 13/220,712

(22) Filed: Aug. 30, 2011

(51) Int. Cl. B25B 13/46

(52) U.S. Cl. 81/63.2

(57) ABSTRACT

A structure of socket wrench includes a wrenching bar having opposite ends of which at least one forming a head. The head and the wrenching bar form an included angle between side-view axes thereof and between top-view axes thereof. The head receives therein a direction-selectable ratchet assembly that includes a driving member. The driving member includes a rotor that is rotatably received in the ratchet assembly. The rotor has a circumference forming at least two socket sections that each have an axis perpendicular to a rotational axis of the rotor. A user may directly turn the rotor to select a desired one among the socket sections of different specifications. Further, the included angles arranged between the wrenching bar and the head allow easy hand gripping and application of force by the user so as to improve the convenience of use.

### (a) TECHNICAL FIELD OF THE INVENTION

The present invention generally relates to a structure of socket wrench

### (b) DESCRIPTION OF THE PRIOR ART

A ratchet wrench is a wrench that can operate in a selected direction and, as shown in FIG. 7, comprises a wrenching bar 50 having opposite ends of which at least one forms a head 55. The head 55 receives therein a ratcheting driving member 56, so that the driving member 56 may provide a driving effect in one direction and ratchet wrench may use the driving member 56 to fit to a corresponding threaded fastener (such as a nut or a bolt head) for tightening and loosening the threaded fastener in a selected direction.

The driving member 56 of the ratchet wrench corresponds to only a single specification of threaded fastener. To handle a threaded fastener of a different specification during the use of the wrench, a replacement ratchet wrench of a corresponding specification must be used. This makes it is necessary for a user to carry multiple ratchet wrenches of various specification in performing an operation and these ratchet wrenches are frequently changed to correspond to the specifications of the workpieces. This unduly increases the frequency of replacement and change, leading to inconvenient operation and poor efficiency.

Further, a conventional ratchet wrench is structured to have the wrenching bar 50 and the head 55 located on the same horizontal plane with a longitudinal axis of the wrenching bar 50 exactly coincident with an axis of the head 55. In case that a threaded fastener is located at a lower site or is very close to a flat surface, it is often found that no sufficient space between the wrenching bar 50 and the flat surface to allow a finger of the user to extend therethrough. This leads to a trouble of gripping the wrench, and sometimes, an undesired included angle have to be formed between the driving member 56 of the head 55 and the threaded fastener, affecting effective fitting between the two. Further, since the longitudinal axis of the wrenching bar 50 is coincident with the axis of the head 55, the amount of space that a user rotates the wrench may be subjected to undue constraint. This leads to the length with which the user may apply a force and also affects the convenience of operation.

To brief, the conventional ratchet wrench is subjected to structural constraint, making it only provides a single specification and requiring frequent replacement of ratchet wrenches of different specifications in performing an operation, and also making it troublesome to grip and apply a force. These make it impossible for the conventional ratchet wrench to meet the needs of practical uses and further improvement is desired.

### SUMMARY OF THE INVENTION

Thus, an objective of the present invention is to provide a structure of socket wrench that is of multiple specifications to allow of efficient switch among different specifications so as to expand the applicability of the socket wrench and reduce the number of socket wrenches of different specifications to be carried.

Another objective of the present invention is to provide a structure of socket wrench that is easy to operate by having a wrenching bar of the socket wrench forming an included angle with respect to a head of the wrench to thereby facilitate hand gripping and applying a force by a user and improve convenience of operation.

In summary, a structure of socket wrench according to the present invention comprises a wrenching bar and a head, which form an included angle both between side-view axes thereof and between top-view axes thereof. Further, the head receives therein a ratchet assembly that comprises a driving member forming a plurality of socket sections so that a user may directly turn the driving member as desired to select a desired one of the socket sections of different specifications. Further, the arrangement of included angle between the wrenching bar and the head allows of easy griping and application of force so as to facilitate the convenience of use and to significantly improve the value of socket wrench to realize economic advantages.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing a socket wrench according to the present invention.

FIG. 2 is an exploded view of the socket wrench according to the present invention showing constituent components and spatial relationship of the components.

FIG. 3 is a side elevational view of the socket wrench according to the present invention showing a side-view included angle between a wrenching bar and a head of the socket wrench.

FIG. 4 is a top plan view of the socket wrench according to the present invention, showing a top-view included angle between the wrenching bar and the head of the socket wrench.

FIG. 5 is a side elevational view illustrating operation of the socket wrench according to the present invention.

FIG. 6 is a top plan view, in a sectioned form, illustrating operation of the socket wrench according to the present invention.

FIG. 7 is a perspective view of a conventional ratchet wrench.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

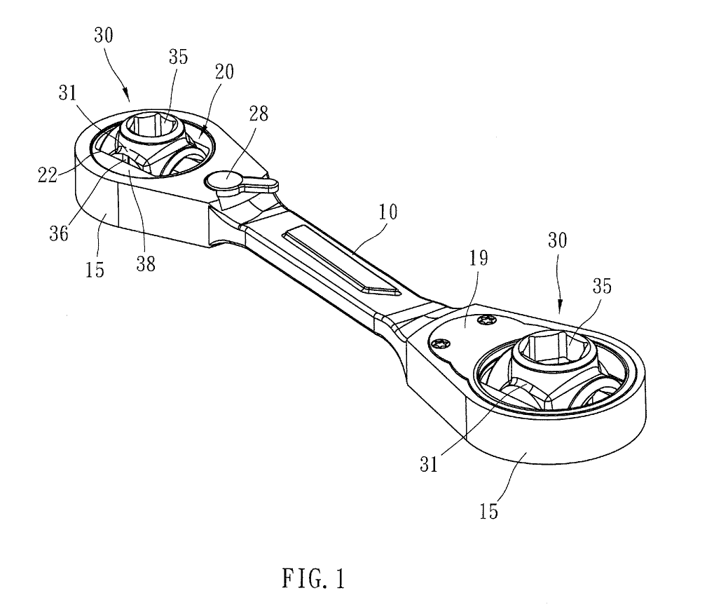

The present invention provides a structure of socket wrench, of which an embodiment is illustrated in FIG. 1 and comprises a wrenching bar 10 in the form of an elongate handle. The wrenching bar 10 has opposite ends of which at least one forms a head 15. In a preferred embodiment, the wrenching bar 10 of the present invention forms two heads 15 respectively on the two ends thereof. The head 15 receives and retains therein a ratchet assembly 20 that can do a driving operation in one direction. The ratchet assembly 20 rotatably receives and retains therein a driving member 30 that forms a plurality of socket sections 35 for respectively driving threaded fasteners (such as nuts and bolts) of different sizes.

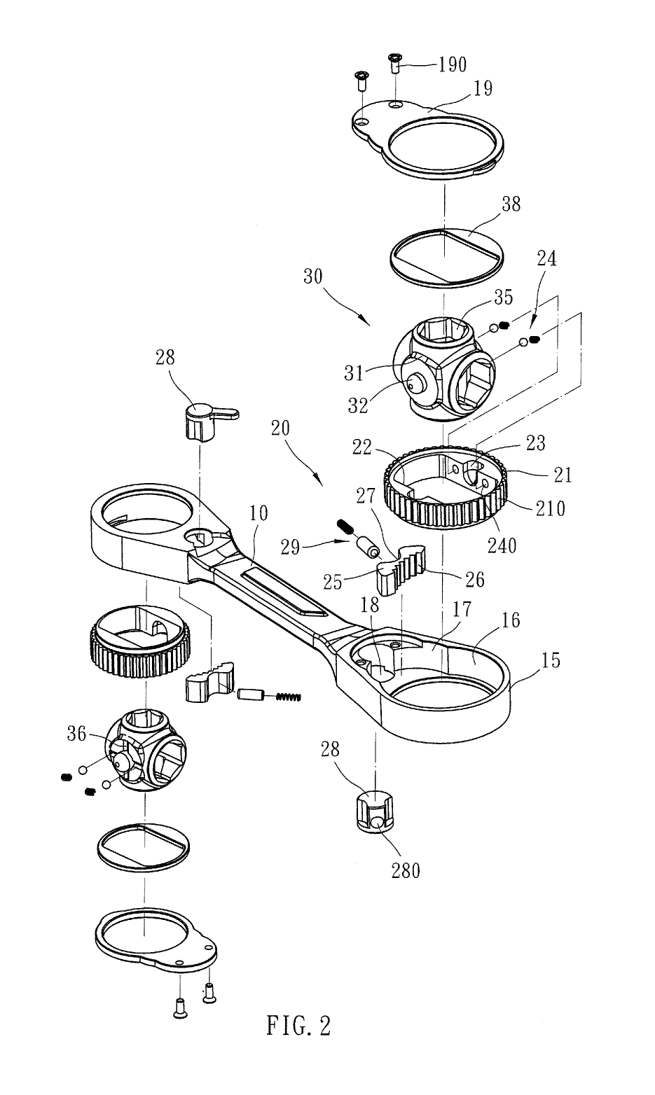

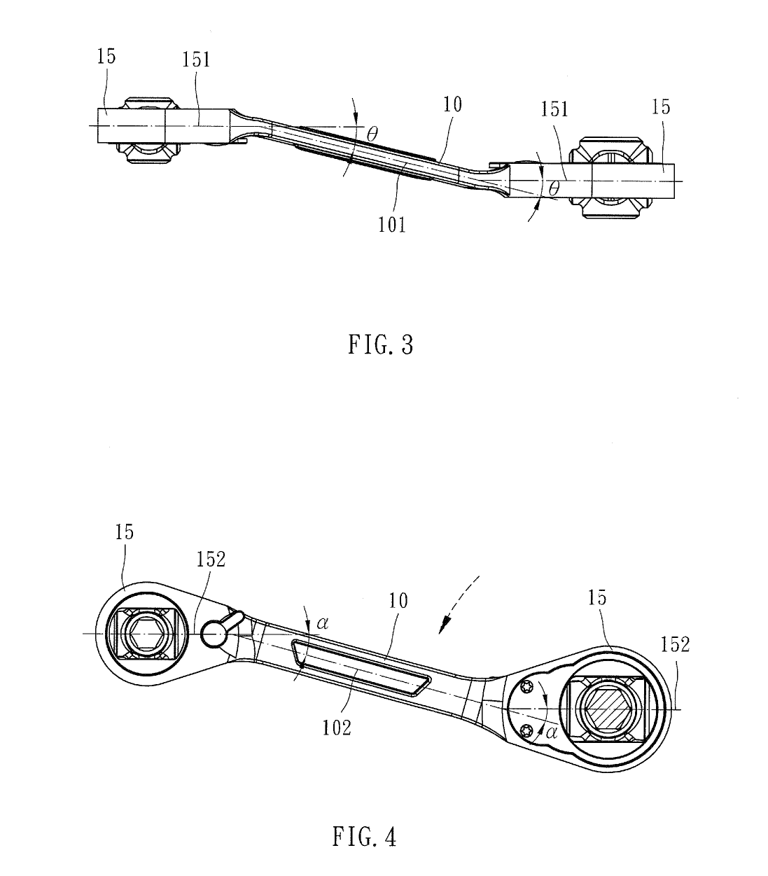

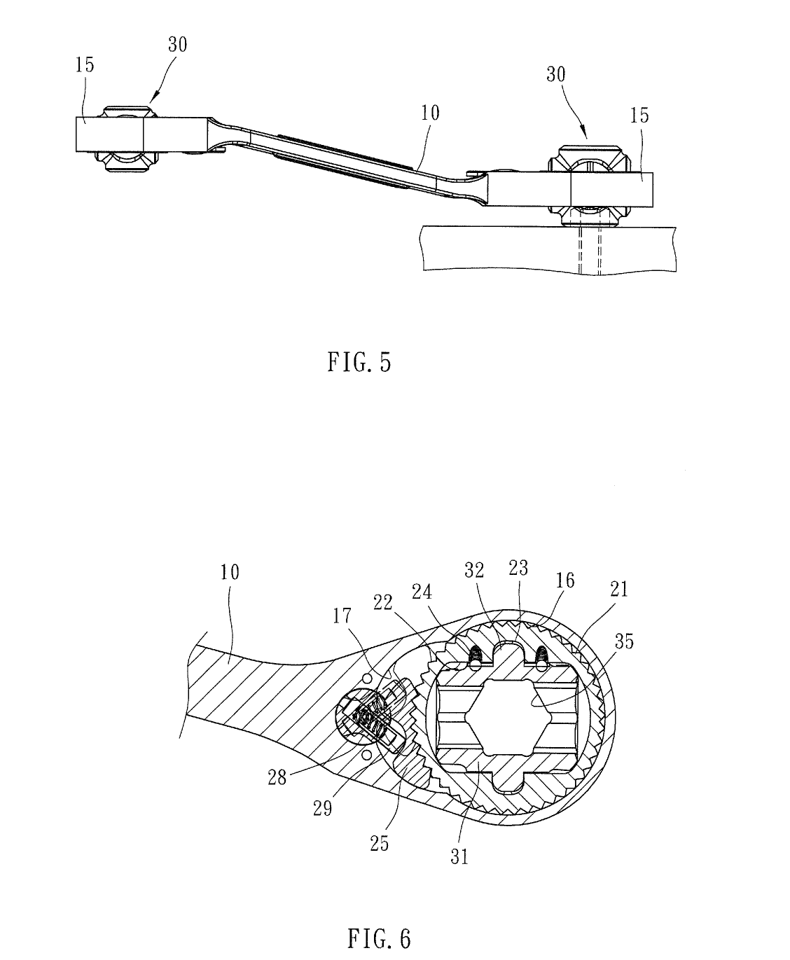

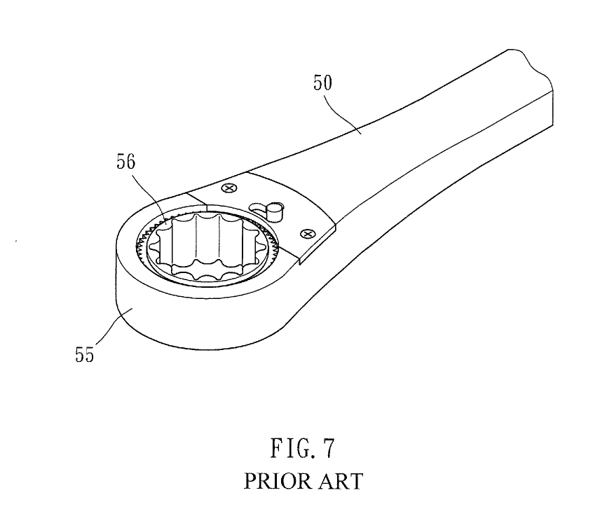

Structure details of the preferred embodiment of the present invention will be described with reference to FIGS. 1 and 2, when the socket wrench is observed from one side (as shown in FIG. 3), the wrenching bar 10 has a side-view longitudinal axis 101 that forms an included angle θ with respect to a side-view head axis 151 of the head 15. The included angle θ preferably ranges from 8 to 35 degrees. When the socket wrench is observed from the top (as shown in FIG. 4), the wrenching bar 10 has a top-view longitudinal axis 102 that forms an included angle a with respect to a top-view head axis 152 of the head 15. The included angle a preferably ranges from 8 to 35 degrees. As such, the wrenching bar 10 and the head 15 form therebetween an included angle when observed from one lateral side or from the top side, to help a user to grip and hold the wrenching bar 10 (as shown in FIG. 5) and operating the wrenching bar 10 for rotating and applying force and also to increase a space (as shown in FIG. 6).

The head 15 of the wrenching bar 10 forms therein a rotation compartment 16, and the rotation compartment 16 receives the ratchet assembly 20 therein. The head 15 forms in a side wall thereof a detent block chamber 17 in communication with the rotation compartment 16. Further, the head 15 also forms a through switch hole 18 at one side of the detent block chamber 17 that is opposite to the rotation compartment 16. The wrenching bar 10 comprises a cover plate 19 that covers a top side of the rotation compartment 16, the detent block chamber 17, and the switch hole 18 of the head 15. The cover plate 19 is secured to the head 15 by at least one fastener 190 to confine the ratchet assembly 20 within the head 15.

The ratchet assembly 20 comprises a ratchet wheel ring 21, a detent block 25, and a switch block 28. The ratchet wheel ring 21 is received in the rotation compartment 16 of the head 15. The ratchet wheel ring 21 has an outer circumference that form a series of ratchet teeth 210. The ratchet wheel ring 21 forms at a central portion thereof a receiving chamber 22 that receives the driving member 30. The ratchet wheel ring 21 forms, in an inner circumference of the receiving chamber 22, two opposite shaft notches 23 for rotatably supporting the driving member 30. Further, the ratchet wheel ring 21 forms in a side wall of the receiving chamber 22 receiving holes 240 that each receive and retain a resilient positioner 24. The resilient positioners 24 provide a releasable position constraint to the driving member 30. In the present invention, each resilient positioner 24 is composed of a steel sphere and a spring. Further, the detent block 25 is received in the detent block chamber 17 of the head 15. The detent block 25 has an end face forming ratchet teeth 26 corresponding to and engageable with the ratchet teeth 210 of the ratchet wheel ring 21. The detent block 25 has an opposite end face forming a curved engagement surface 27. The switch block 28 is received in the switch hole 18 of the head 15. The switch block 28 has one side opposing the detent block 25 and forming a receiving hole 280, which receives and retains therein a resilient retention block 29. The resilient retention block 29 is engageable with and positioned against the curved engagement surface 27 of the detent block 25. In the present invention, the resilient retention block 29 is composed of a steel sphere and a spring to allow a user to access and use the switch block 28 from outside the socket wrench to change the direction along which the detent block 25 fixes the ratchet wheel ring 21 so as to change driving mode of the ratchet wheel ring 21 of the ratchet assembly 20 by the wrenching bar 10.

Further, the driving member 30 comprises a rotor 31 that is rotatably received inside the ratchet wheel ring 21 of the ratchet assembly 20. The rotor 31 has opposite side surfaces forming two shaft sections 32 respectively projecting therefrom and corresponding to the shaft notches 23 of the ratchet wheel ring 21. The rotor 31 has a rotational axis that is substantially perpendicular to a rotational axis of the ratchet wheel ring 21. Further, the rotor 31 has a circumference that forms at least two socket sections 35 that are perpendicular to the rotational axis. According to the embodiment of the present invention, the rotor 31 forms four socket sections 35 that are of different specifications for fitting to threaded fasteners of different specifications. Further, the rotor 31 forms one or more positioning slots 36 in one of the side surfaces thereof that opposes the resilient positioner 24 to respectively correspond to the socket section 35. The positioning slots 36 are receivingly engageable with the resilient positioners 24 of the ratchet wheel ring 21 for releasably retaining purposes, so that through predetermined angular displacement of the rotor 31, one of the socket sections 35 are positioned to face downward.

As such, a structure of socket wrench that allows easy change of specification and ready operation is formed.

With the structure described above, in practical use of the present invention, as shown in FIGS. 1 and 2, when an attempt is made to change to a socket section 35 of the driving member 30 that is of a different specification in the use of the wrench, based on the specification of the threaded fastener that needs to be tightened or un-tightened, the rotor 31 is turned about the shaft sections 32 that are rotated within the shaft notches 23 of the ratchet wheel ring 21 of the ratchet assembly 20 to have the one of the socket sections 35 of the rotor 31 that corresponds to the threaded fastener facing downward. Once the rotor 31 is so positioned, the resilient positioners 24 of the ratchet wheel ring 21 are allowed to fit into and retain the positioning slots 36 of the rotor 31 to fix the rotor 31 in such a position and to avoid undesired rotation of the rotor 31 of the driving member 30 during the operation of the wrench thereby improving the convenience of use and operation.

As shown in FIGS. 5 and 6, since the wrenching bar 10 and the heads 15 of the socket wrench, when observed from both the side view and the top view, form an included angle θ, α therebetween. This allows of easy gripping by a user (as shown in FIG. 5) and facilitates a user to apply a force thereto and increases the space for operation (as shown in FIG. 6) thereby significantly improving convenience of operation.

To change the driving direction of the socket wrench, the switch block 28 of the ratchet assembly 20 is pushed to allow the switch block 28 to push the detent block 25 through the resilient retention block 29 so as to change the engagement relationship of the detent block with the ratchet wheel ring 21 (as shown in FIG. 6), thereby allowing the detent block 25 to form effective retaining engagement with the ratchet wheel ring 21 in a given direction and also allowing the ratchet wheel ring 21 to perform a ratcheting operation by causing simultaneous rotation of the rotor 31 in one direction but showing idle rotation in an opposite direction. As such, the socket wrench may use the socket section 35 of the rotor 31 to selectively drive a workpiece for tightening and/or loosening.

With the above described structure and operation, the socket wrench according to the present invention provides a driving member 30 comprising rotor 31 that carries multiple socket sections 35 of different specifications thereby showing a configuration of one tool with multiple specifications. This allows a user to directly turn the rotor 31 based on a desired specification so as to select and use a desired one of the socket sections 35. Compared to the conventional tools, the present invention shows a significant reduction or working hours and also reduces the number of socket wrenches of different specifications to be carried. Further, the present invention provides a structure that improves the efficiency of changing different specifications. Due to the single-direction driving feature of the socket wrench according to the present invention, the present invention can be used to selectively tighten or loosen a workpiece, so that the present invention provides advantages of efficient and convenient uses. Further, the socket wrench according to the present invention comprises a wrenching bar 10 and a head 15 that are arranged to form an included angle θ, α between top-view axes and side-view axes thereof to facilitate hand gripping and application of force by a user and thereby improving convenience of operation.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

1-5. (canceled)

6. A structure of socket wrench, comprising a wrenching bar, the wrenching bar having opposite ends at least one of which forms a head, the head receiving therein a ratchet assembly operable for driving in one direction, the ratchet assembly rotatably receiving therein a driving member that forms a plurality of socket sections:
wherein the wrenching bar and the head respectively form a side-view longitudinal axis and a side-view head axis when observed from a side view and also form a top-view longitudinal axis and a top-view head axis when observed from a top view, the side-view longitudinal axis of the wrenching bar and the side-view head axis of the head forming therebetween an included angle, the top-view longitudinal axis of the wrenching bar and the top-view head axis of the head forming therebetween an included angle, the head forming therein a rotation compartment for receiving the ratchet assembly, the head having a side wall forming a detent block chamber in communication with the rotation compartment, the head forming a through switch hole at one side of the detent block chamber that is opposite to the rotation compartment;
the ratchet assembly comprising a ratchet wheel ring, a detent block, and a switch block, wherein the ratchet wheel ring is received in the rotation compartment, the ratchet wheel ring having an outer circumference that form a series of ratchet teeth, the ratchet wheel ring forming at a central portion thereof a receiving chamber that receives the driving member, the detent block being received in the detent block chamber of the head, the detent block having an end face forming ratchet teeth corresponding to and engageable with the ratchet teeth of the ratchet wheel ring, the detent block having an opposite end face forming a curved engagement surface, the switch block being received in the switch hole, the switch block comprising a resilient retention block that corresponds to the detent block and is positionable against the curved engagement surface of the detent block;
the driving member comprising a rotor that is rotatably received inside the ratchet wheel ring of the ratchet assembly, the rotor having a rotational axis that is substantially perpendicular to a rotational axis of the ratchet wheel ring, the rotor having a circumference that forms at least two socket sections that are perpendicular to the rotational axis;
the ratchet wheel ring of the ratchet assembly forming in an inner circumference of the receiving chamber two opposite shaft notches, the rotor of the driving member having opposite side surfaces forming shaft sections projecting therefrom and corresponding to the shaft notches; and
the ratchet wheel ring of the ratchet assembly comprising a resilient positioner mounted on a side wall of the receiving chamber, the rotor of the driving member forming one or more positioning slots in one side surface thereof opposing the resilient positioner to respectively correspond to the socket sections, the positioning slots being selectively receiving and engageable with the resilient positioner for releasably retaining purpose.

7. The structure of socket wrench according to claim 6, wherein the included angle formed between the side-view longitudinal axis of the wrenching bar and the side-view head axis of the head is between 8 and 35 degrees and the included angle formed between the top-view longitudinal axis of the wrenching bar and the top-view head axis of the head is between 8 and 35 degrees.

8. The structure of socket wrench according to claim 6, wherein a cover plate is set to cover a top side of the rotation compartment, the detent block chamber, and the switch hole of the head of the wrenching bar, the cover plate being secured to the head by at least one fastener.
